(19) United States
(12) Patent Application Publication
(10) Pub. No.: US 2026/0111718 A1
(43) Pub. Date: Apr. 23, 2026

(54) NEURAL NETWORK ACCELERATOR AND METHOD FOR OPERATING THE SAME

(71) Applicant: UIF (University Industry Foundation), Yonsei University, Seoul (KR)

(72) Inventors: William Jinho SONG, Seoul (KR); Taesoo LIM, Seoul (KR); Hyeonjin KIM, Seoul (KR); Jingu PARK, Seoul (KR); Bogil KIM, Seoul (KR)

(21) Appl. No.: 19/293,729

(22) Filed: Aug. 7, 2025

(30) Foreign Application Priority Data
Aug. 13, 2024 (KR) 10-2024-0108259

(51) Int. Cl. G06N 3/063

(52) U.S. Cl. CPC G06N 3/063

(57) ABSTRACT

A neural network accelerator includes a PE array which includes a plurality of processing elements arranged in an array and connected to each other by a first connection line in a row direction and a second line in a column direction, and is capable of transmitting data in a rotational manner in the row and column directions by processing elements arranged at one end in the row and column directions being connected to the other end by first and second torus connection lines, respectively, and a mapping controller that receives mapping information including sizes and data information of a plurality of partition computational layers obtained by evenly partitioning a computational layer included in a neural network, sets a utilization space, and sets a plurality of utilization spaces for the plurality of partition computational layers to be sequentially arranged in a row direction of a PE array.

### CROSS-REFERENCE TO RELATED APPLICATIONS

This application claims priority under 35 U.S.C. § 119(a) to Korean Patent Application No. 10-2024-0108259, filed on Aug. 13, 2024, with the Korean Intellectual Property Office, the disclosure of which is incorporated herein in its entirety by reference.

### TECHNICAL FIELD

The present disclosure relates to a neural network accelerator and a method for operating the same, and more particularly, to a neural network accelerator capable of suppressing aging and a method for operating the same.

### BACKGROUND ART

Due to the rapid advancement of neural network technology, a neural network is being utilized in a variety of fields, and its performance is continuously improving. Accordingly, a neural network accelerator (NNA) has been proposed and utilized to efficiently perform neural network calculations.

A neural network accelerator is configured to process large amounts of data in parallel by including a plurality of processing elements (PE) arranged in a two-dimensional array. In the neural network accelerator, data to be processed is partitioned and allocated based on a size of a buffer provided to each processing element (PE) for calculation, and a result of the calculation from each of the plurality of processing elements (PE) is transmitted and propagated to an adjacent processing element (PE), enabling data to be re-utilized across time and space.

As is well known, a neural network model consist of a plurality of computational layers, and each of the plurality of computational layers has varying dimensions and sizes. Furthermore, the neural network accelerator is equipped with a large number of processing elements (PE) arranged to provide a high level of parallelism for data to be processed in these computational layers having varying dimensions and sizes. Therefore, the dimensions and sizes of the computational layers in the neural network model do not match the arrangement of the processing elements (PE) of the neural network accelerator.

As a result, some of the arranged processing elements (PE) participate in processing data in the computational layers, while others are unable to participate in data processing.

FIG. 1 shows a heatmap based on an arrangement and a utilization frequency of processing elements in a neural network accelerator. In FIG. 1, (a) displays a plurality of processing elements arranged two-dimensionally with a width (w) and a height (h) of 14×12, and processing elements utilized according to sizes of different computational layers, separately, and (b) and (c) show heatmaps based on a utilization frequency of processing elements arranged as in (a) when the well-known neural network models, ResNet-50 and SqueezeNet, are used, respectively.

Typically, a direction in which each of the plurality of processing elements (PE) arranged in the neural network accelerator transmits data to an adjacent processing element is designated. For example, each of the plurality of processing elements (PE) arranged two-dimensionally can transmit data to processing elements (PE) arranged adjacent to it in rightward and upward directions. In a case of such an arrangement, a processing element (PE) at the lower left end can only transmit data, and cannot receive it. Therefore, when the neural network accelerator processes data for each computational layer, as shown in FIG. 1, it sets the processing element (PE) at the lower left end, which cannot receive data from adjacent processing elements (PE), as a fixed starting point, so that partitioned data is allocated and processed from the processing element disposed at the starting point.

However, a neural network not only includes a plurality of computational layers of various sizes, but also often processes data repeatedly. Nevertheless, as shown in (a) of FIG. 1, even though a utilization space (Utilization Space 1, 2, 3) may differ depending on a size of each computational layer, data for all computational layers is allocated and processed from a processing element at the same starting point position.

As a result, as shown in (b) and (c) of FIG. 1, processing elements closer to the starting point are utilized more frequently for data processing, while processing elements arranged farthest from the starting point are utilized significantly less frequently and are rarely utilized. Consequently, the plurality of processing elements significantly differ in frequency of use depending on where they are arranged. This imbalance in frequency of use across processing elements causes processing elements near the starting point, which are frequently utilized, to wear out faster than other processing elements, which ultimately accelerates the aging of an entire neural network accelerator.

### SUMMARY

### Technical Problem

The purpose of the present disclosure is to provide a neural network accelerator capable of preventing aging by leveling out wear on processing elements, and a method for operating the same.

The purpose of the present disclosure is to provide a neural network accelerator capable of leveling out wear on processing elements by connecting a plurality of processing elements arranged in an array in a torus-connected structure so that subsequent calculations begin at a position next to a position of a processing element utilized in a previous calculation in repeated calculations, and a method for operating the same.

Solution to Problem

According to an aspect of the present disclosure, there is a neural network accelerator including a PE array which includes a plurality of processing elements arranged in an array and connected to each other by a first connection line in a row direction and a second line in a column direction, and is capable of transmitting data in a rotational manner in the row and column directions by processing elements arranged at one end in the row and column directions being connected to the other end by first and second torus connection lines, respectively; and a mapping controller that receives mapping information including sizes and data information of a plurality of partition computational layers obtained by evenly partitioning a computational layer included in a neural network, sets a utilization space, which is a region including processing elements for processing data of the partition computational layers according to the mapping information within the PE array, and sets a plurality of utilization spaces for the plurality of partition computational layers to be sequentially arranged in a row direction of a PE array, which is virtually repeatedly rearranged in the row and column directions by the first and second torus connection lines.

The mapping controller may calculate a least common multiple of a width of the utilization space designated according to the mapping information and a width of the PE array, virtually rearrange the PE array in the row direction a number of times corresponding to the least common multiple according to a rotation structure by the first and second torus connection lines, and set a position of the utilization space so that the utilization space is arranged consecutively in the row direction by a number corresponding to the calculated least common multiple in a plurality of virtually rearranged PE arrays.

The mapping controller, when the number of the partition computational layers is greater than a value obtained by dividing a least common multiple calculated between the width of the utilization space designated according to the mapping information and the width of the PE array by the width of the utilization space, may arrange the utilization space consecutively in the row direction by a number corresponding to the obtained value.

The mapping controller, when the number of the partition computational layers is greater than the value obtained by dividing the least common multiple by the width of the utilization space, may arrange the utilization space consecutively in the row direction by the obtained value, and arrange a utilization space for the remaining partition computational layers consecutively in the row direction again after being vertically shifted in the column direction.

The mapping controller may arrange a plurality of utilization spaces arranged by being vertically shifted in the column direction consecutively in the row direction again from the same position as a starting position of utilization spaces arranged consecutively in a previous row direction.

The mapping controller, when mapping information on other computational layers included in the neural network is acquired, may arrange a plurality of utilization spaces for the other computational layers consecutively in the row direction from a last utilization space arranged according to mapping information for a previous computational layer.

The mapping controller, when mapping information on other computational layers included in the neural network is acquired, may arrange the plurality of utilization spaces consecutively in the row direction or consecutively in the column direction from the last utilization space depending on a size of the utilization space for the other computational layer, a size of the utilization space for the previous computational layer, and a position of the last arranged utilization space.

The mapping controller, when a size of each computational layer is compared with a size of the PE array and the size of the computational layer is larger than the size of the PE array, may acquire mapping information on a plurality of partition computational layers obtained by evenly partitioning the computational layer.

The neural network accelerator may include a global buffer that transmits data including input data and weights to each of a plurality of processing elements included in the utilization space under control of the mapping controller, and receives and stores a result of processing the data by the plurality of processing elements included in the utilization space.

According to another aspect of the present invention, there is a method for operating a neural network accelerator which includes a PE array including a plurality of processing elements arranged in an array and connected to each other by a first connection line in a row direction and a second line in a column direction, and capable of transmitting data in a rotational manner in the row and column directions by processing elements arranged at one end in the row and column directions being connected to the other end by first and second torus connection lines, respectively, and a mapping controller. The method is performed by the mapping controller and includes receiving mapping information including sizes and data information of a plurality of partition computational layers obtained by evenly partitioning a computational layer included in a neural network, and setting a utilization space, which is a region including processing elements for processing data of the partition computational layers in the PE array according to the mapping information, such that a plurality of utilization spaces for a plurality of partition computational layers are sequentially arranged consecutively in a row direction of the PE array, which is virtually repeatedly rearranged in the row and column directions by the first and second torus connection lines.

### Advantageous Effects of Invention

According to the present invention, the neural network accelerator and the method for operating the same of the present disclosure can prevent aging by leveling out wear on processing elements by conneting a plurality of processing elements arranged in an array in a torus connection structure so that subsequent calculations begin at a position next to a position of a processing element utilized in a previous calculation in repeated calculations.

### BRIEF DESCRIPTION OF DRAWINGS

FIG. 1 shows a heat map based on an arrangement and a utilization frequency of processing elements in a neural network accelerator;

FIG. 2 shows a schematic configuration of a neural network accelerator according to an embodiment;

FIG. 3 shows an example of a method for connecting processing elements;

FIGS. 4 and 5 are diagrams for describing an example of how a mapping controller of FIG. 2 designates a utilization space;

FIG. 6 is a diagram for describing another example of how the mapping controller of FIG. 2 designates a utilization space;

FIG. 7 shows a method for operating the neural network accelerator according to one embodiment; and

FIG. 8 is a diagram for describing a computing environment including a computing device according to one embodiment.

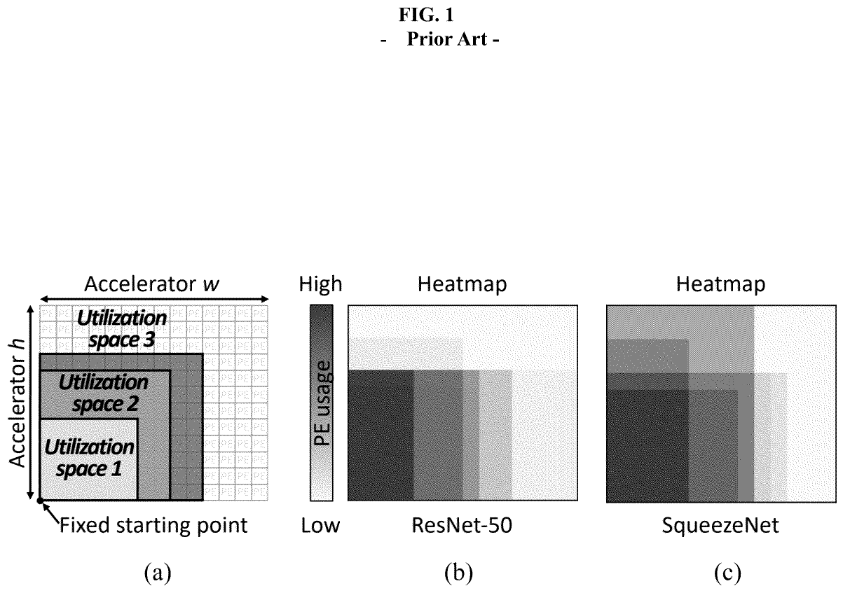

### DESCRIPTION OF EMBODIMENTS

Hereinafter, specific embodiments of the present disclosure will be described with reference to the drawings. The following detailed description is provided to facilitate a comprehensive understanding of a method, a device, and/or a system described herein. However, this description is provided merely as an example and the present invention is not limited thereto.

In describing the embodiments of the present disclosure, detailed descriptions of known technologies related to the present invention will be omitted if they are deemed to unnecessarily obscure the gist of the embodiments. Furthermore, terms described below are defined in consideration of functions in the present invention and may vary depending on the intent or custom of a user or operator. Therefore, their definitions should be based on an overall content of this specification. Terms used in the detailed description are intended to describe only one embodiment and should not be construed as limiting. Unless expressly stated otherwise, singular forms include plural forms. In this description, expressions such as “include” or “have” are intended to indicate certain characteristics, numbers, steps, operations, elements, parts or combinations thereof, and should not be construed to exclude the presence or possibility of one or more other characteristics, numbers, steps, operations, elements, parts or combinations thereof other than those described. In addition, terms such as “part,” “unit,” “module,” and “block” described in the specification mean a unit that processes at least one function or operation, which may be implemented by hardware, software, or a combination of hardware and software.

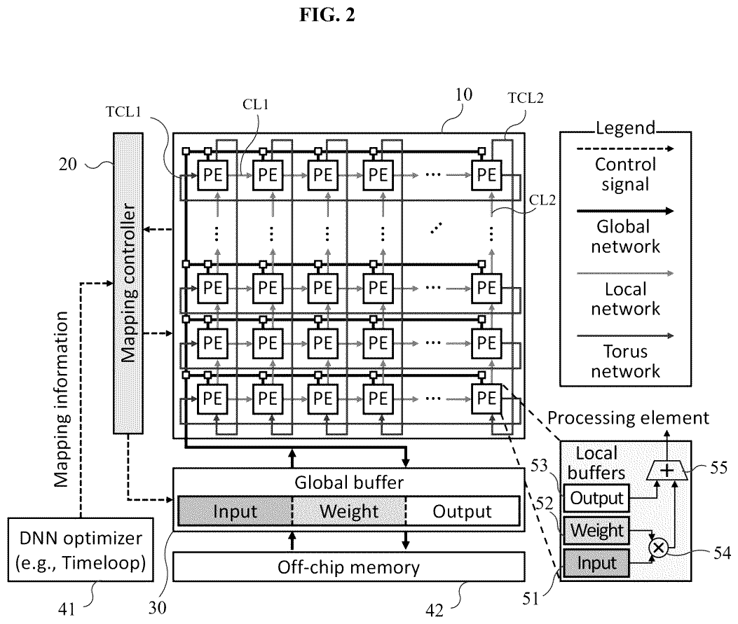

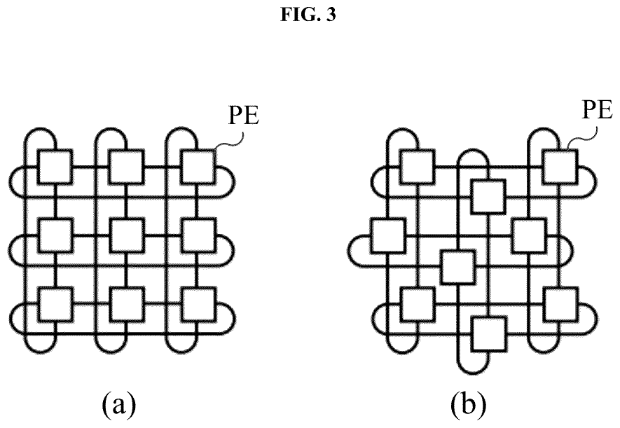

FIG. 2 shows a schematic configuration of a neural network accelerator according to the embodiment, and FIG. 3 shows an example of a method for connecting processing elements.

Referring to FIG. 2, a neural network accelerator according to one embodiment may include a PE array 10, a mapping controller 20, and a global buffer 30. The PE array 10 includes a plurality of processing elements (PE) arranged in a two-dimensional array. Among the plurality of processing elements (PE), processing elements arranged adjacent to each other in a row direction may be connected via a first connection line CL1, and processing elements arranged adjacent to each other in a column direction may be connected via a second connection line CL2. Each of the first and second connection lines CL1 and CL2 is configured to allow a processing element (PE) to transmit data to an adjacent processing element, and a direction in which data is transmitted is designated as a single direction. For example, the first connection line CL1 allows each processing element (PE) to transmit data to an adjacent processing element on one side (here, for example, on the right side) in the row direction, and the second connection line CL2 allows each processing element (PE) to transmit data to an adjacent processing element on one side (here, for example, on the upper side) in the column direction. As in FIG. 2, when the first connection line CL1 is configured to transmit data to the right side and the second connection line CL2 is configured to transmit data to the upper side, a processing element (PE) arranged at the lower left end can only transmit data to an adjacent PE, whereas a processing element (PE) arranged at the upper right end can only receive data from an adjacent PE.

Additionally, the data transmitted via the first connection line CL1 and the second connection line CL2 can also be set to be different. For example, the first connection line CL1 can be used to sequentially transmit input data input to a computational layer of a neural network, and the second connection line CL2 can be used to sequentially transmit a plurality of weights which constitute the computational layer and partial sums, which are results of computations performed by processing elements.

Each of the plurality of processing elements (PE) can be configured, as shown on the lower right end, to include a local buffer consisting of an input buffer 51, a weight buffer 52, and an output buffer 53, a multiplier 54, and an adder 55. Here, the weight buffer 52 and the input buffer 51 receive and store one of the plurality of weights and one of a plurality of pieces of input data transmitted from the global buffer 30. Here, the weight buffer 52 and the input buffer 51 can store weights and input data transmitted from the global buffer 30 through other processing elements (PE) depending on positions where the processing elements (PE) are arranged. Here, each of the processing elements (PE) can receive and store a weight and input data designated by the mapping controller 20.

The output buffer 53 can receive and store partial sums, which are results of calculations performed by adjacent processing elements (PE). Since it is assumed that each processing element (PE) transmits an acquired partial sum to an adjacent processing element above via the second connection line CL2, the output buffer 53 can store the partial sum acquired by an adjacent processing element below performing a previous calculation.

The multiplier 54 receives the input data stored in the input buffer 51 and the weights stored in the weight buffer 52, performs a multiplication calculation, and transmits a result to the adder 55. The adder 55 receives an output of the multiplier 54 and the partial sums stored in the output buffer 53, and adds them to acquire a partial sum. The adder then transmits the acquired partial sum to an adjacent processing element (PE), and causes it to be stored in the output buffer 53 of the adjacent processing element.

The mapping controller 20 receives mapping information according to a configuration of a plurality of computational layers constituting the neural network from a neural network optimizer 41, and designates weights and input data to be stored in each of the plurality of processing elements (PE) of the PE array 10 according to the received mapping information. That is, a plurality of pieces of input data and a plurality of weights are allocated to the plurality of processing elements (PE) so that the PE array 10 can perform a calculation according to an computational layer. At this time, the mapping controller 20 first designates an area of a processing element (PE) to which data to be processed at one time is allocated in the PE array 10 according to the mapping information. Here, the designated area of a processing element (PE) is called a utilization space (US). When the utilization space (US) is designated, the mapping controller 20 controls the PE array 10 and the global buffer 30 so that data is allocated to processing elements (PE) arranged within the designated utilization space (US).

The neural network optimizer 41 analyzes a configuration of the neural network to perform partitioning and scheduling so that the neural network accelerator can efficiently perform an operation required by the neural network. The neural network optimizer 41 can first divide a plurality of computational layers constituting the neural network, partition each of the divided computational layers into a size that can be performed at once by the neural network accelerator again, and transmit the partitioned information to the mapping controller 20. For example, if a computational layer has a three-dimensional configuration in directions of width (w), height (h), and channel (c), the neural network optimizer 41 can maintain the width (w) and height (h) of the computational layer as they are, but divide it evenly into a plurality of pieces in a direction of a channel (c) axis, and transmit mapping information on the partitioned computational layer, i.e., partition computational layer, to the mapping controller 20. However, when the number of processing elements (PE) provided in the PE array 10 is greater than a size of the computational layer, the neural network optimizer 41 can also transmit mapping information on an unpartitioned computational layer to the mapping controller 20.

The neural network optimizer 41 may be configured to be provided externally to the neural network accelerator, but in some cases, it may be configured to be included in the mapping controller 20.

Under control of the mapping controller 20, the global buffer 30 temporarily receives and stores input data and weights stored in an external off-chip memory 42, and transmits the stored input data and weights to the PE array 10 so that the input data and weights may be stored in the processing element (PE) designated by the mapping controller 20. Moreover, it receives and stores partial sums output from the PE array 10, and transmits the stored partial sums to the off-chip memory 42.

The off-chip memory 42 is a memory device provided externally to the neural network accelerator. It stores the plurality of weights included in each of the plurality of computational layers constituting the neural network, and input data to be calculated in the computational layers. Moreover, it receives and stores results of calculations for the computational layers executed by the PE array 10 from the global buffer 30. The global buffer 30 and the off-chip memory 42 may each transmit the stored results of calculations to the global buffer 30 and the PE array 10 as input data for a next calculation to be performed by the PE array 10.

Meanwhile, a first torus line TCL1 connecting two processing elements arranged at both side ends in the same row among a plurality of arranged processing elements (PE) and a second torus connection line TCL2 connecting two processing elements arranged at the upper and lower ends in the same column are further formed in the PE array 10 according to one embodiment.

As described above, the first and second connection lines CL1 and CL2 are configured to connect only processing elements (PE) arranged adjacent to each other among the plurality of processing elements (PE) arranged in the PE array 10. Therefore, processing elements (PE) arranged at edges of the PE array 10 are connected by the first and second connection lines CL1 and CL2 in only two directions, and are not connected in the other two directions. Specifically, in an example of FIG. 2, processing elements (PE) arranged at the right-side end cannot transmit data in the row direction, and processing elements (PE) arranged at the upper end cannot transmit data in the column direction.

Consequently, an existing mapping controller 20 sets the lower left end as a starting point to ensure that data to be allocated to the plurality of processing elements (PE) according to mapping information does not exceed ranges of the upper and right-side ends of the PE array 10. Data of a computational layer is then allocated and arranged from the set starting point according to the mapping information, which results in relatively significant wear on processing elements (PE) surrounding the starting point.

However, as shown in FIG. 2, in the neural network accelerator of one embodiment, a first torus connection line TCL1 connecting processing elements (PE) arranged at the right-side end and processing elements (PE) arranged at the left-side end, and a second torus connection line TCL2 connecting processing elements (PE) arranged at the upper end and processing elements (PE) arranged at the lower end are further formed in the PE array 10. When the first and second torus connection lines TCL1 and TCL2 are further formed in this manner, the plurality of processing elements of the PE array 10 have a rotation structure in the row and column directions. Accordingly, the processing elements (PE) arranged at the right-side end can transmit data to the processing elements (PE) arranged at the left-side end, and the processing elements (PE) arranged at the upper end can transmit data to the processing elements (PE) arranged at the lower end. This can be seen that the processing elements (PE) arranged at the left-side end are rotated and rearranged again on a right side of the processing elements (PE) arranged at the right-side end of the PE array 10, and the processing elements arranged at the lower end are rotated and rearranged again on an upper side of the processing elements (PE) arranged at the upper end. That is, it can be seen that the PE array 10 is repeatedly rearranged in the row and column directions. Therefore, even if the data of the computational layer according to the mapping information goes beyond a range of the upper and right-side ends of the PE array 10, the PE array 10 can perform a neural network calculation normally required without a change in performance.

In FIG. 2 and (a) of FIG. 3, the first and second torus connection lines TCL1 and TCL2 are formed to extend as long as a length of the PE array 10 in both the row and column directions and appear to have very long paths. However, as shown in (b) of FIG. 3, the first and second connection lines CL1 and CL2 and the first and second torus connection lines TCL1 and TCL2 can be easily implemented without having relatively long paths as compared to the connection lines CL1 and CL2 by interconnecting other processing elements (PE) in a zigzag pattern.

Since the first and second torus connection lines TCL1 and TCL2 are formed within the PE array 10, an area where computation can be performed is not restricted by the upper and right-side ends of the PE array 10. Therefore, the mapping controller 20 can designate a utilization space (US) according to mapping information regardless of a size of the PE array 10. That is, a position of the starting point can be set arbitrarily. Accordingly, the mapping controller 20 of one embodiment changes the starting point of the utilization space (US) based on each piece of mapping information each time to prevent relative wear of a certain processing element (PE) from increasing due to its high utilization frequency compared to other processing elements. At this time, the mapping controller 20 sets the starting point so that the plurality of processing elements (PE) in the PE array 10 are utilized as evenly as possible.

The following describes in detail how the mapping controller 20 performs wear leveling to ensure that utilization frequencies of the processing elements (PE) become even.

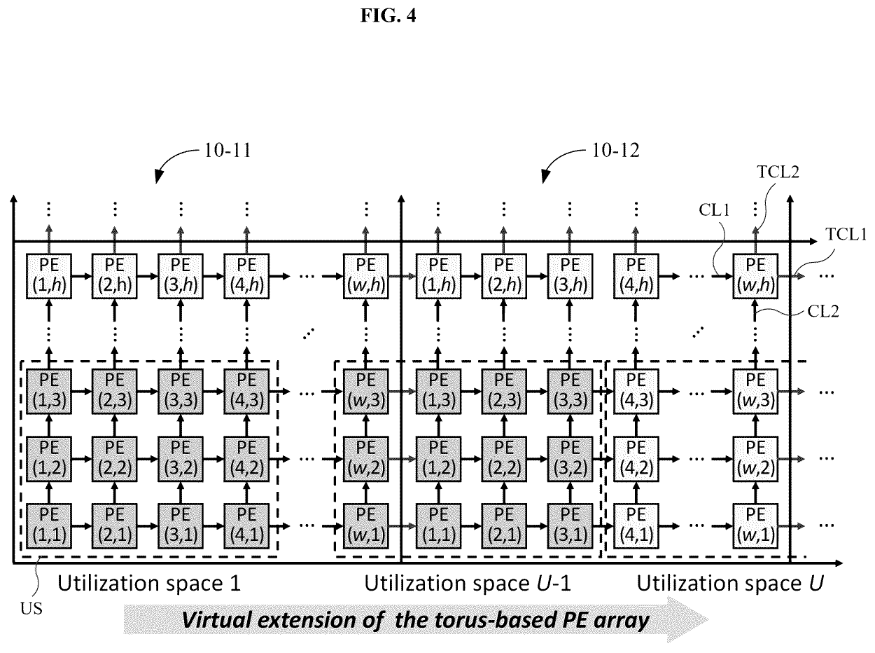

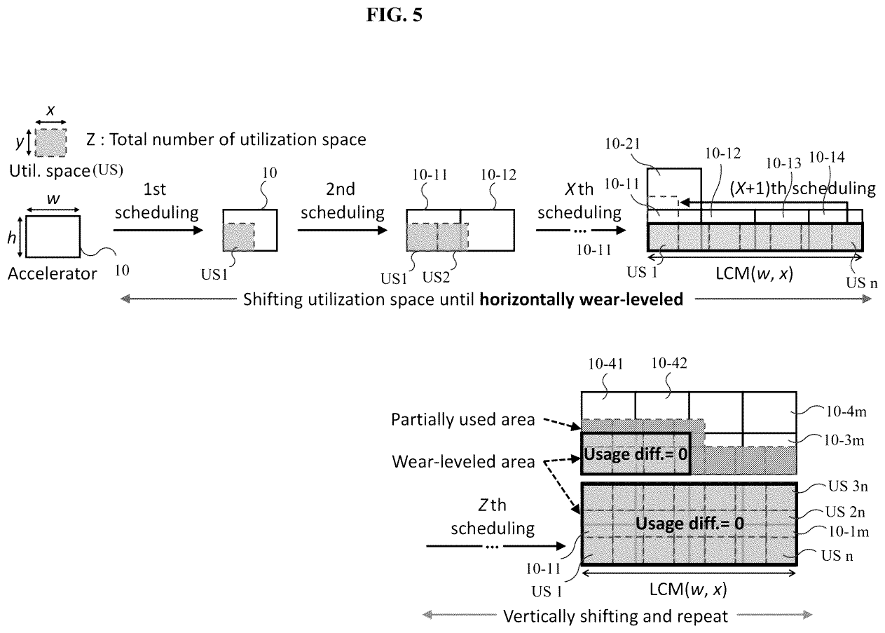

FIGS. 4 and 5 are diagrams for describing an example of how the mapping controller of FIG. 2 designates a utilization space.

As described above, in the PE array 10 shown in FIG. 2, data of processing elements (PE) arranged at one end of the PE array 10 can be rotated and transmitted to the other end via the first and second torus connection lines TCL1 and TCL2. Since the first and second torus connection lines TCL1 and TCL2 connect both side ends and the upper and lower ends of the PE array 10, it can be seen that the PE array 10 is repeatedly rearranged virtually in rightward and upward directions in a data transmission process via the first and second torus connection lines TCL1 and TCL2, as shown in FIGS. 4 and 5. In FIGS. 4 and 5, to divide the virtually repeatedly rearranged PE arrays (10) from each other, the virtually re-arranged PE arrays (10) are displayed differently (10-11, 10-12, . . . , 10-21, . . . ) according to their arrangement positions by borrowing a positional representation of a matrix.

FIG. 4 shows a simple example where the PE array 10 is rearranged once to the right side from an initial PE array 10-11. The mapping controller 20 first sets a plurality of utilization spaces to be arranged so that they do not overlap each other in the row direction and are consecutively horizontally shifted in the plurality of virtually rearranged PE arrays 10-11 and 10-12. As described above, the computational layer may be larger than the PE array 10 in size, and accordingly the mapping controller 20 may set a plurality of utilization spaces US 1 to US U for each of a plurality of partition computational layers partitioned to equal sizes according to the mapping information in the plurality of virtually rearranged PE arrays 10-11 and 10-12. Since the PE array 10 is repeatedly rearranged, the mapping controller 20 may set a utilization space to be arranged at an arbitrary position regardless of the size of the PE array 10. For example, in FIG. 4, a (U-1)^{th} utilization space (US U-1) is arranged across a 11^{th} PE array 10-11 and a 12^{th} PE array 10-12.

As shown in FIG. 4, the mapping controller 20 first sets the plurality of utilization spaces US 1 to US U to be arranged by being consecutively horizontally shifted in the row direction, based on the plurality of PE arrays 10-11 and 10-12 rearranged in the row direction. The mapping controller 20 can also arbitrarily designate a position of an initially set utilization space (US 1). However, for ease of understanding, it is assumed that, as before, a processing element (PE) at the lower left end is used as a starting point (1, 1), and the plurality of utilization spaces (US 1) are set to be arranged sequentially by being horizontally shifted in the row direction from the lower left end.

And as shown in FIG. 5, the mapping controller 20 calculates a least common multiple (LCM) between a width (w) of a PE array 10, that is, a row-wise size according to the number of columns, and a width (x) of a utilization space (US) acquired according to the mapping information, and arranges the utilization space repeatedly in the row direction by a value (LCM(w,x)/x=n) obtained by dividing the calculated least common multiple (LCM(w,x)) by the width (x) of the utilization space (US). At this time, the PE array 10 can be rearranged repeatedly by a value (LCM(w,x)/w=m) obtained by dividing the least common multiple (LCM(w,x)) by the width (w) of the PE array 10. In other words, n utilization spaces (US 1 to US n) can be arranged in the row direction in m PE arrays 10-11 to 10-1m rearranged in the row direction.

When the utilization spaces (US 1 to US n) are repeatedly arranged as many as a value (n) corresponding to the least common multiple (LCM) of the width (w) of the PE array 10 and the width (x) of the utilization space (US), the plurality of processing elements (PE) arranged in the row direction in the PE array 10 are utilized an equal number of times, regardless of a size difference between the width (w) of the PE array 10 and the width (x) of the utilization space (US). In other words, the processing elements (PE) are worn out evenly.

However, this corresponds to processing elements (PE) within a height (y) range of the utilization space (US), and processing elements (PE) arranged beyond the height (y) range of the utilization space (US) are not utilized.

Therefore, when n utilization spaces (US 1 to US n) are sequentially arranged by being horizontally shifted in the row direction according to the least common multiple (LCM) of the width (w) of the PE array 10 and the width (x) of the utilization space (US), the mapping controller 20 arranges a next utilization space (US n+1) consecutively by being vertically shifted in the column direction.

At this time, the mapping controller 20 may arrange it consecutively to the initially arranged utilization space (US 1) among the previously arranged utilization spaces (US 1 to US n) in the column direction. For example, when the starting point of the utilization space (US 1) is (1, 1) as described above, a starting point of the utilization space (US n+1) arranged above the utilization space (US 1) can be (y+1, 1) according to the height (y) of the utilization space (US 1). Then, the mapping controller 20 arranges n utilization spaces (US n+1 to US 2n) in the row direction again according to the least common multiple (LCM). That is, the processing elements (PE) arranged above are also made to be worn out evenly. That is, the mapping controller 20 can arrange the utilization space (US) consecutively by being horizontally shifted in the row direction in units of an integer multiple of the value (n) obtained by dividing the least common multiple (LCM) by the width (x) of the utilization space (US). And when the integer multiple of the obtained value (n) is exceeded, the utilization space is arranged by being vertically shifted in the column direction and then horizontally shifted in the row direction again.

However, even if the next utilization space (US n+1) is arranged above the utilization space (US n) that is previously arranged lastly, remaining utilization spaces (US n+2, . . . ) are arranged by being consecutively horizontally shifted in the row direction again, and thus the processing elements (PE) arranged above can be evenly worn out. Therefore, a starting position of a utilization space (US) arranged above can also be adjusted variably.

As described above, the mapping controller 20 repeats a process in which a utilization space is arranged by being horizontally shifted in the row direction by a number (n) corresponding to the least common multiple (LCM) of the width (w) of the PE array 10 and the width (x) of the utilization space (US), and vertically shifted in the column direction and horizontally shifted again in the row direction by the value (n) corresponding to the least common multiple (LCM).

Depending on the number of utilization spaces (US), some of the processing elements (PE) among the plurality of processing elements (PE) of the PE array 10 may be utilized more repeatedly than other processing elements (PE), resulting in a difference in utilization frequency (usage diff.). An area where the difference in utilization frequency occurs in this manner is referred to as a residual space. The number of processing elements (PE) included in the residual space where the difference in utilization frequency occurs is much smaller than before. In addition, the difference in utilization frequency also occurs with a difference smaller than the value (n) corresponding to the least common multiple (LCM). Therefore, by ensuring that the processing elements (PE) are utilized as evenly as possible compared to conventional methods, a difference in wear-level between the processing elements (PE) can be significantly reduced, thereby suppressing aging of the neural network accelerator.

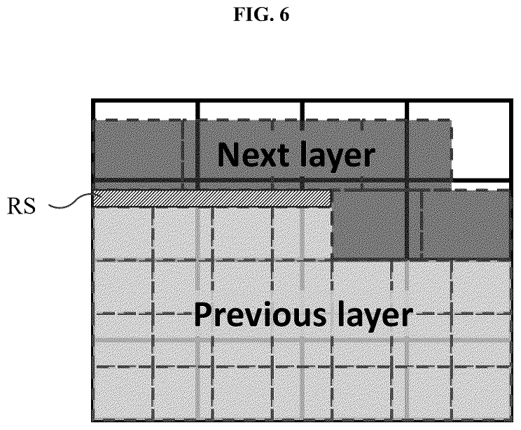

FIG. 6 is a diagram for describing another example of how the mapping controller of FIG. 2 designates a utilization space.

As described above, a plurality of utilization spaces (US) partitioned and designated within a single computational layer have the same size. Therefore, most processing elements (PE) in the PE array 10 have the same utilization frequency, and the remaining processing elements (PE) also have utilization frequency that differs by less than the value (n) corresponding to the least common multiple (LCM). However, this difference in utilization frequency can accumulate due to repeated neural network operations, resulting in the difference in wear-level between the processing elements (PE).

However, a neural network is composed of a plurality of computational layers. Accordingly, as shown in FIG. 6, when arrangement positions of utilization spaces for a next computational layer are set after utilization spaces for the previous computational layer have been arranged and executed, the mapping controller 20 arranges them consecutively in the row or column direction from a position of a last utilization space among the utilization spaces set for the previous computational layer. As shown in FIG. 6, when an initial utilization space for the next computational layer is arranged consecutively in the row direction from the last utilization space for the previous computational layer, the difference in utilization frequency may occur in some processing elements (PE) due to a difference between a height (y) of the utilization spaces for the previous computational layer and a height (y′) of the utilization spaces for the next computational layer, resulting in existence of a residual space. However, a size of the residual space can be greatly reduced.

FIG. 6 shows, as an example, a case where the initial utilization space for the next computational layer is arranged to be consecutive in the row direction from the last utilization space of the previous computational layer. However, the size of the residual space resulting from the consecutive arrangement of the utilization spaces for the next computational layer varies not only depending on the difference between the height (y) of the utilization spaces for the previous computational layer and the height (y′) of the utilization spaces for the next computational layer, but also depending on a difference in distance between a right-side end of the last utilization space of the previous computational layer and a right-side end of the repeatedly rearranged PE array 10.

For example, when a difference between the height (y) of the utilization spaces for the previous computational layer and the height (y′) of the utilization spaces for the next computational layer, set according to the mapping information, is greater than a height of the residual space, an area not previously included in the residual space may be additionally included in the residual space. In addition, even if the last utilization space of the previous computational layer is close to a right-side end of an m^{th} rearranged PE array (10-1m), when the utilization spaces for the next computational layer are arranged consecutively, the size of the residual space may unnecessarily increase.

Accordingly, the mapping controller 20 can arrange the utilization spaces of the next computational layer in the row-or column direction to further reduce the size of the residual space.

Although a residual space may always occur due to a difference in size between the utilization spaces for the previous computational layer and the utilization spaces for the next computational layer, a position where a residual space occurs varies each time calculation is performed for each computational layer due to a difference in size between utilization spaces for a plurality of computational layers. Furthermore, since the neural network models perform iterative calculations, a difference in utilization frequency due to such a residual space is very small compared to a total utilization frequency of each processing element (PE). As a result, the difference in wear-level between the processing elements (PE) is reduced, thereby suppressing the aging of the neural network accelerator.

In the shown embodiment, each component may have different functions and capabilities in addition to those described above, and may include additional components that are not described above. Additionally, in one embodiment, each configuration may be implemented using one or more physically divided devices, or may be implemented by one or more processors or a combination of one or more processors and software, and may not be clearly divided in specific operations, unlike the shown example.

The neural network accelerator shown in FIG. 2 can be implemented within a logic circuit using hardware, firmware, software, or a combination thereof, or can be implemented using a general-purpose or special-purpose computer. The device can be implemented using a hardwired device, a field programmable gate array (FPGA), an application-specific integrated circuit (ASIC), or the like. Moreover, the device can be implemented as a system-on-chip (SoC) including one or more processors and controllers.

Furthermore, the neural network accelerator can be installed in a computing device or server equipped with hardware elements in a form of software, hardware, or a combination thereof. The computing device or server can refer to various devices, including, in whole or in part, a communication device such as a communication modem for communicating with various devices or wired or wireless communication networks, a memory for storing data for executing programs, and a microprocessor for executing programs to perform calculations and issue commands.

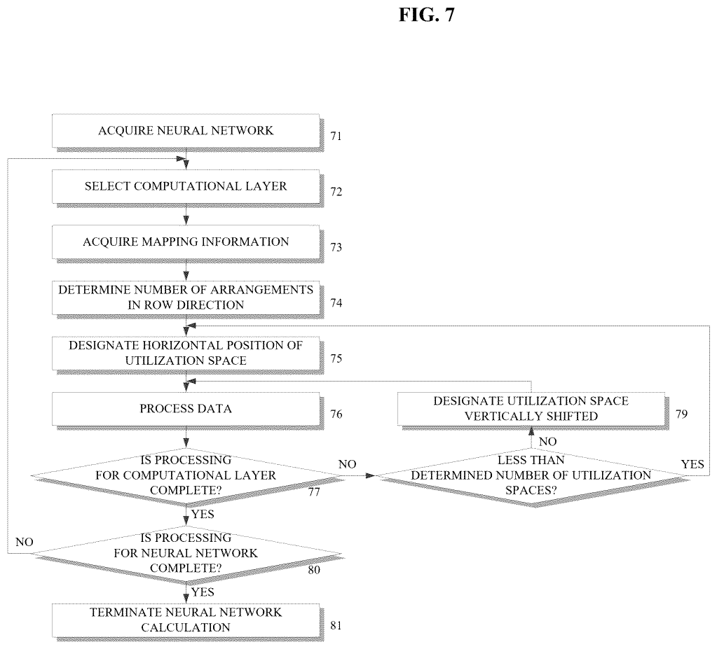

FIG. 7 shows a method for operating the neural network accelerator according to one embodiment.

The method for operating the neural network accelerator shown in FIG. 7 can be performed by the mapping controller 20. Here, the description is provided on an assumption that the neural network optimizer 41 is included in the mapping controller 20.

Referring to FIG. 7, the method for operating the neural network accelerator according to one embodiment includes acquiring, by the mapping controller 20, a neural network to be processed (71). The acquired neural network is then divided into a plurality of computational layers, and the divided computational layers are sequentially selected one by one (72).

Once a computational layer is selected, the selected computational layer is analyzed to acquire mapping information (73). At this time, sizes of the computational layer and the PE array 10 are compared to partition the computational layer into a plurality of layers and mapping information designating sizes and data of each partitioned computational layer can be acquired. The information on data herein may be a memory address stored in an offset memory.

Once the mapping information is acquired, to process a computational layer selected according to the acquired mapping information, a size of a utilization space (US) depending on the partitioned computational layer is confirmed, and the number (m) of PC arrays (10) and the number (n) of utilization spaces (US) to be rearranged are determined based on a width (x) of the confirmed utilization space (US) and the width (w) of the PE array 10. At this time, the number (m) of PC arrays (10) and the number (n) of utilization spaces (US) are calculated by calculating first the least common multiple (LCM) of the width (x) of the utilization space (US) and the width (w) of the PE array 10. The number (n) of utilization spaces (US) to be arranged in the row direction can be determined by using the value (LCM(w,x)/x=n) obtained by dividing the calculated least common multiple (LCM(w,x)) by the width (x) of the utilization space (US), and the number (m) of PE arrays (10) to be rearranged in the row direction can be determined by using the value (LCM(w,x)/w=m) obtained by dividing the least common multiple (LCM(w,x)) by the width (w) of the PE array 10.

Once the number (m) of PC arrays (10) and the number (n) of utilization spaces (US) to be rearranged are determined, among the plurality of processing elements (PE) arranged in the PE array 10, processing elements for processing data of the computational layer according to the mapping information are selected to designate a row-wise position, that is, a horizontal position, of a utilization space (75). Here, the plurality of processing elements (PE) arranged in the PE array 10 can transmit data to adjacent processing elements in the row and column directions unidirectionally via the first and second connection lines CL1 and CL2, respectively, and processing elements (PE) arranged at one end in the row and column directions can transmit data to processing elements (PE) arranged at the other end via the first and second torus connection lines TCL1 and TCL2. Therefore, a utilization space (US) can be designed up to a position of the PE array 10 that is virtually consecutively adjacent and rearranged beyond a boundary of the PE array 10. A position of the utilization space (US) to be designated is horizontally shifted and designated so that it is consecutive in the row direction from a last position of a previously designated utilization space (US).

When the position of the utilization space (US) is designated, data is allocated to the designated utilization space (US) and the allocated data is processed (76). Then, it is determined whether processing for the selected computational layer is complete (77). When it is determined that the processing for the selected computational layer is not complete, it is determined whether the number of designated utilization spaces (US) is less than the determined number (n) of utilization spaces (78). When the number of designated utilization spaces (US) is less than the determined number (n) of utilization spaces (US), a next utilization space (US) is horizontally shifted and designated so that it is consecutive in the row direction from the last position of a previously designated utilization space (US) (75). However, when the number of designated utilization spaces (US) reaches the determined number of utilization spaces (US) (n), the next utilization space (US) is designated by being vertically shifted (79). In other words, the utilization space (US) is horizontally shifted in the row direction and arranged consecutively in units of an integer multiple of the value (n) obtained by dividing the least common multiple (LCM) by the width (x) of the utilization space (US). When the integer multiple of the value (n) is exceeded, the utilization space (US) is arranged by being vertically shifted in the column direction and then horizontally shifted in the row direction again.

At this time, the utilization space (US) vertically shifted may be arranged from the same column position as a column position of an initially designated utilization space (US) in a computational layer, but the present invention is not limited thereto.

Meanwhile, when it is determined that the processing for the computational layer is complete, it is determined whether processing for the acquired neural network is complete (80). When the processing for the neural network is determined to be complete, neural network calculation of the neural network accelerator is terminated (81). However, when the processing for the neural network is determined not to be complete, a next unselected computational layer of the neural network is selected (72). Mapping information for the selected computational layer is then acquired to arrange a utilization space (US). At this time, a utilization space (US) of a next computational layer can be arranged at a consecutive position in the row or column direction from a last utilization space (US) of a previous computational layer.

While FIG. 7 depicts sequential execution of each process, this is merely an example. Those skilled in the art can apply the processes by modifying and transforming them in various manners, such as changing and executing the order described in FIG. 7, executing one or more processes in parallel, or adding other processes within a range not departing from the essential characteristics of the embodiments of the present invention.

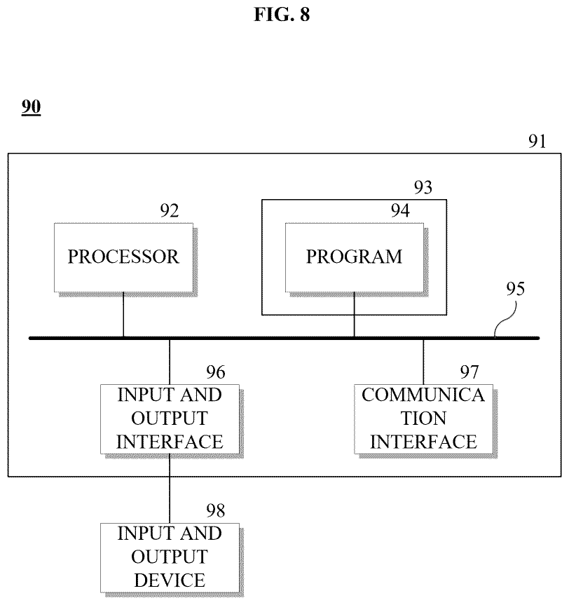

FIG. 8 is a diagram for describing a computing environment including a computing device according to one embodiment.

In the shown embodiment, respective components may have different functions and capabilities in addition to those described below, and may include additional components in addition to those described below. A shown computing environment 90 includes a computing device 91 and can perform a method of operating the neural network accelerator shown in FIG. 7. In one embodiment, the computing device 91 may be one or more components included in the neural network accelerator shown in FIG. 2.

The computing device 91 includes at least one processor 92, a computer-readable storage medium 93, and a communication bus 95. The processor 92 may cause the computing device 91 to operate according to the exemplary embodiments described above. For example, the processor 92 may execute one or more programs 94 stored on the computer-readable storage medium 93. The one or more programs 94 may include one or more computer-executable instructions, and the computer-executable instructions may be configured to cause, when executed by the processor 92, the computing device 91 to perform operations according to an exemplary embodiment.

A communication bus 95 interconnects various other components of the computing device 91, including the processor 92 and the computer-readable storage medium 93.

The computing device 91 may also include one or more input and output interfaces 96 and one or more communication interfaces 97, which provide interfaces for one or more input and output devices 98. The input and output interfaces 96 and the communication interfaces 97 are connected to the communication bus 95. The input and output devices 98 may be connected to other components of the computing device 91 via the input and output interfaces 96. Exemplary input and output devices 98 may include input devices such as a pointing device (such as a mouse or trackpad), a keyboard, a touch input device (such as a touchpad or touchscreen), a voice or sound input device, various types of sensor devices, and/or a photographing devices, and/or output devices such as a display device, a printer, a speaker, and/or a network card. The exemplary input and output device 98 may be incorporated into the computing device 91 as a component of the computing device 91, or may be connected to the computing device 91 as a separate device distinct from the computing device 91.

While the present invention has been described in detail through representative embodiments above, those skilled in the art will appreciate that various modifications and other equivalent embodiments are possible. Therefore, the true scope of the present invention should be determined by the technical spirit of the appended claims.

What is claimed is:

1. A neural network accelerator comprising:
a PE array which includes a plurality of processing elements arranged in an array and connected to each other by a first connection line in a row direction and a second line in a column direction, and is capable of transmitting data in a rotational manner in the row and column directions by processing elements arranged at one end in the row and column directions being connected to the other end by first and second torus connection lines, respectively; and
a mapping controller that receives mapping information including sizes and data information of a plurality of partition computational layers obtained by evenly partitioning a computational layer included in a neural network, sets a utilization space, which is a region including processing elements for processing data of the partition computational layers according to the mapping information within the PE array, and sets a plurality of utilization spaces for the plurality of partition computational layers to be sequentially arranged in a row direction of a PE array, which is virtually repeatedly rearranged in the row and column directions by the first and second torus connection lines.

2. The neural network accelerator according to claim 1,
wherein the mapping controller calculates a least common multiple of a width of the utilization space designated according to the mapping information and a width of the PE array,
virtually rearranges the PE array in the row direction a number of times corresponding to the least common multiple according to a rotation structure by the first and second torus connection lines, and
sets a position of the utilization space so that the utilization space is arranged consecutively in the row direction by a number corresponding to the calculated least common multiple in a plurality of virtually rearranged PE arrays.

3. The neural network accelerator according to claim 1,
wherein, when the number of the partition computational layers is greater than a value obtained by dividing a least common multiple calculated between the width of the utilization space designated according to the mapping information and the width of the PE array by the width of the utilization space, the mapping controller arranges the utilization space consecutively in the row direction by a number corresponding to the obtained value.

4. The neural network accelerator according to claim 3,
wherein, when the number of the partition computational layers is greater than the value obtained by dividing the least common multiple by the width of the utilization space, the mapping controller arranges the utilization space consecutively in the row direction by the obtained value, and arranges a utilization space for the remaining partition computational layers consecutively in the row direction again after being vertically shifted in the column direction.

5. The neural network accelerator according to claim 4,
wherein the mapping controller arranges a plurality of utilization spaces arranged by being vertically shifted in the column direction consecutively in the row direction again from the same position as a starting position of utilization spaces arranged consecutively in a previous row direction.

6. The neural network accelerator according to claim 1,
wherein, when mapping information on other computational layers included in the neural network is acquired, the mapping controller arranges a plurality of utilization spaces for the other computational layers consecutively in the row direction from a last utilization space arranged according to mapping information for a previous computational layer.

7. The neural network accelerator according to claim 1,
wherein, when the mapping information on other computational layers included in the neural network is acquired, the mapping controller arranges the plurality of utilization spaces consecutively in the row direction or consecutively in the column direction from the last utilization space depending on a size of the utilization space for the other computational layer, a size of the utilization space for the previous computational layer, and a position of the last arranged utilization space.

8. The neural network accelerator according to claim 1,
wherein, when a size of each computational layer is compared with a size of the PE array and the size of the computational layer is larger than the size of the PE array, the mapping controller acquires mapping information on a plurality of partition computational layers obtained by evenly partitioning the computational layer.

9. The neural network accelerator according to claim 1,
wherein the neural network accelerator includes a global buffer that transmits data including input data and weights to each of a plurality of processing elements included in the utilization space under control of the mapping controller, and receives and stores a result of processing the data by the plurality of processing elements included in the utilization space.

10. A method for operating a neural network accelerator which includes a PE array including a plurality of processing elements arranged in an array and connected to each other by a first connection line in a row direction and a second line in a column direction, and capable of transmitting data in a rotational manner in the row and column directions by processing elements arranged at one end in the row and column directions being connected to the other end by first and second torus connection lines, respectively, and a mapping controller, which is performed by the mapping controller, the method comprising:
receiving mapping information including sizes and data information of a plurality of partition computational layers obtained by evenly partitioning a computational layer included in a neural network; and
setting utilization spaces, which are regions including processing elements for processing data of the partition computational layers in the PE array according to the mapping information, such that a plurality of utilization spaces for a plurality of partition computational layers are sequentially arranged consecutively in a row direction of the PE array, which is virtually repeatedly rearranged in the row and column directions by the first and second torus connection lines.

11. The method for operating a neural network accelerator according to claim 10, wherein the setting utilization spaces to be sequentially arranged includes
calculating a least common multiple of a width of the utilization space designated according to the mapping information and a width of the PE array,
virtually rearranging the PE array in the row direction a number of times corresponding to the least common multiple according to a rotation structure by the first and second torus connection lines, and
setting a position of the utilization space so that the utilization space is arranged consecutively in the row direction by a number corresponding to the calculated least common multiple in a plurality of virtually rearranged PE arrays.

12. The method for operating a neural network accelerator according to claim 11, wherein the setting utilization spaces to be sequentially arranged includes:
when the number of the partition computational layers is greater than a value obtained by dividing the least common multiple calculated between the width of the utilization space designated according to the mapping information and the width of the PE array by the width of the utilization space, horizontally shifting the utilization space in the row direction to be consecutively arranged by a number corresponding to the obtained value.

13. The method for operating a neural network accelerator according to claim 12, wherein the setting utilization spaces to be sequentially arranged includes:
when the number of the partition computational layers is greater than the value obtained by dividing the least common multiple by the width of the utilization space, arranging the utilization space consecutively in the row direction by the obtained value, and arranging a utilization space for the remaining partition computational layers consecutively in the row direction again after being vertically shifted in the column direction.

14. The method for operating a neural network accelerator according to claim 13, wherein the setting utilization spaces to be sequentially arranged includes:
arranging a plurality of utilization spaces arranged by being vertically shifted in the column direction consecutively in the row direction again from the same position as a starting position of utilization spaces consecutively arranged in a previous row direction.

15. The method for operating a neural network accelerator according to claim 10, wherein the setting utilization spaces to be sequentially arranged includes:
when mapping information on other computational layers included in the neural network is acquired, arranging a plurality of utilization spaces for the other computational layers consecutively in the row direction from a last utilization space arranged according to the mapping information for the previous computational layer.

16. The method for operating a neural network accelerator according to claim 10, wherein the setting utilization spaces to be sequentially arranged includes:
when mapping information on other computational layers included in the neural network is acquired, arranging the plurality of utilization spaces for the other computational layers consecutively in the row direction or consecutively in the column direction from the last utilization space depending on a size of the utilization space for the other computational layer, a size of a utilization space for the previous computational layer, and a position of the last arranged utilization space.

17. The method for operating a neural network accelerator according to claim 10, wherein the receiving the mapping information includes:
when a size of each computational layer is compared with a size of the PE array and the size of the computational layer is larger than the size of the PE array, acquiring mapping information on a plurality of partition computational layers obtained by evenly partitioning the computational layer.

18. The method for operating a neural network accelerator according to claim 10, further comprising:
transmitting data including input data and weights stored in a global buffer to each of a plurality of processing elements included in the utilization space, and storing a result of processing the data by a plurality of processing elements included in the utilization space in the global buffer.
